(19) United States
(12) Patent Application Publication
(10) Pub. No.: US 2009/0214720 A1
(43) Pub. Date: Aug. 27, 2009

(54) Cake based frozen confection sandwich and method for making same

(76) Inventors: Andres Francisco Almenares, Miami, FL (US); Oslanier Almenares, Miami, FL (US)

Correspondence Address: RUBEN ALCOBA, ESQ., 3399 NW 72 AVENUE, SUITE211, MIAMI, FL, 33122, US

(21) Appl. No.: 12/072,466

(22) Filed: Feb. 26, 2008

(51) Int. Cl. A23G 9/48; A23P 1/08

(52) U.S. Cl. 426/101; 426/275

(57) ABSTRACT

A frozen sandwich having a first baked food product layer, having an upper surface and a lower surface; a frozen confection layer having an upper surface and a lower surface, the frozen confection layer is positioned so that the upper surface of the frozen confection layer contacts the lower surface of the first baked food product layer; and a second baked food product layer, having an upper surface and a lower surface, the second baked food product layer is positioned so that the upper surface of the second baked food product layer contacts lower surface of the frozen confection layer.

The method for making the frozen sandwich is also provided. The method essentially includes the steps of providing a dough, forming the dough, baking the dough, preparing the baked dough, preparing a frozen confection, building a sandwich by combining the baked dough with the frozen confection, and freezing the sandwich.

### BACKGROUND

The present invention is a frozen ice cream sandwich, wherein the upper and lower layers of the sandwich are cake and the center layer is a frozen confection and a method for making same.

The inventor conceived the present invention while preparing deserts in his kitchen.

The combination of the ingredients used, the portions used, and the method of preparation yielded a novel taste and texture that the inventor has not seen, felt, or tasted elsewhere.

In addition to the novel taste and texture of the present invention, the inventor specifically avoided using ingredients that are high in saturated fats; such as oil, an oil substitute, butter, or a butter substitute, that are typically found in baked food products, as such the present invention is lower in saturated fats than other food products comprising baked dough.

The method of preparing the present invention comprises, inter alia, steps for dividing a single piece of baked dough into eight (8) pieces of baked dough, by doing so, the majority of the baked dough used in the present invention does not have the baked crust typically associated with baked food products. The substantial lack of baked crust gives the consumer a unique texture in their mouth when eating baked food product portion of the present invention.

The unique proportions of ingredients used in preparing the baked food product layers of present invention creates a baked food product that when frozen is substantially solid and when thawed is rigid enough to maintain the structural integrity of the sandwich, yet supple enough to be eaten with ease.

An objective of the present invention is to provide a frozen sandwich with a unique taste and texture.

Another objective of the present invention is to provide a food product that can be frozen for storage and thawed for consumption.

Yet another objective of the present invention is to provide a food product that is low in saturated fats, yet maintains an appealing flavor for consumers.

Information relevant to attempts to address these objectives can be found in U.S. Pat. No. 5,789,008, U.S. Pat. No. 6,156,357, and U.S. Pat. No. 4,910,030. However, each one of these references suffers from one or more of the following disadvantages: the references do not provide for a baked food product layer with the same ingredients, the references do not yield a baked food product with the same taste, the references do not yield a baked food product with the same texture, the references do no yield a baked food product low in saturated fats, and the references do not provide for a similar method in making the food products claimed therein.

For the foregoing reasons, there is a need for a novel frozen ice cream sandwich, wherein the upper and lower layers of the sandwich are cake and the center layer is a frozen confection and a novel method for making same.

### SUMMARY

The present invention is directed to a frozen sandwich and a novel method for making same.

The frozen sandwich has a first baked food product layer, having an upper surface and a lower surface; a frozen confection layer having an upper surface and a lower surface, the frozen confection layer is positioned so that the upper surface of the frozen confection layer contacts the lower surface of the first baked food product layer; and a second baked food product layer, having an upper surface and a lower surface, the second baked food product layer is positioned so that the upper surface of the second baked food product layer contacts lower surface of the frozen confection layer.

The method for making the same comprises the steps of providing a dough, forming the dough, baking the dough, preparing the baked dough, preparing a frozen confection, building a sandwich by combining the baked dough with the frozen confection, and freezing the frozen sandwich.

### DRAWINGS

These and other features, aspects and advantages of the present invention will become better understood with regard to the following description, appended claims and drawings where:

FIG. 1 shows a front perspective view of one embodiment of the present invention.

### DESCRIPTION

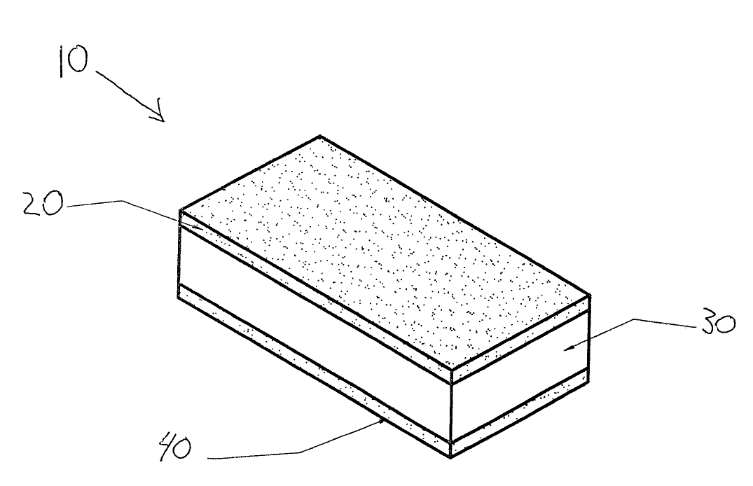

As shown in FIG. 1, a frozen sandwich 10, comprising first baked food product layer 20, having an upper surface and a lower surface; a frozen confection layer 30 having an upper surface and a lower surface, and a second baked food product layer 40, having an upper surface and a lower surface.

The first baked food product layer preferably contains wheat flour or a wheat flour substitute in an amount of from about 30% to about 38% based on the total weight of the first baked food product layer, sugar or a sugar substitute in an amount of from about 21% to 29% based on the total weight of the first baked food product layer, and egg or egg substitute in an amount of from about 35% to 43% based on the total weight of the first baked food product layer.

The second baked food product layer preferably contains wheat flour or a wheat flour substitute in an amount of from about 30% to about 38% based on the total weight of the second baked food product layer, sugar or a sugar substitute in an amount of from about 21% to 29% based on the total weight of the second baked food product layer, and egg or egg substitute in an amount of from about 35% to 43% based on the total weight of the second baked food product layer.

The frozen confection layer preferably comprises a frozen dairy product or frozen dairy product substitute.

The frozen confection layer is positioned so that the upper surface of the frozen confection layer contacts the lower surface of the first baked food product layer and the lower surface of the frozen confection layer contacts the upper surface of the second baked food product layer.

The method for making the present invention comprises the steps of providing a dough, forming the dough, baking the dough, preparing the baked dough, preparing a frozen confection, building a sandwich by combining the baked dough with the frozen confection, and freezing the frozen sandwich.

It has been found that a delicious cake-like baked product layer with unique taste and texture can be prepared using the following formula. Mixing a raw cake dough mixture comprising wheat flour or a wheat flour substitute in an amount of from about 30% to about 38% based on the total weight of the a cake dough, sugar or a sugar substitute in an amount of from about 21% to 29% based on the total weight of the a cake dough, and egg or egg substitute in an amount of from about 35% to 43% based on the total weight of the a cake dough, thereby creating a mixture comprising wheat flour or a wheat flour substitute, sugar or a sugar substitute, and egg or an egg substitute. Specifically it has been found that one might first beat egg whites or egg whites substitute, in an amount of from about 54% to 62% based on the total weight of the egg or egg substitute, until the egg whites or egg white substitute is fluffy, thereby creating the first element of the mixture comprising wheat flour or a wheat flour substitute, sugar or a sugar substitute, and egg or an egg substitute. Then one might add sugar or sugar substitute in an amount of from about 21% to 29% based on the total weight of the a cake dough mixture, to the first element of the mixture, thereby creating the second element of the mixture comprising wheat flour or a wheat flour substitute, sugar or a sugar substitute, and egg or an egg substitute. Then one might add wheat flour or wheat flour substitute in an amount of from about 30% to about 38% based on the total weight of the a cake dough mixture to the second element of the mixture, thereby creating the third element of the mixture comprising wheat flour or a wheat flour substitute, sugar or a sugar substitute, and egg or an egg substitute. And lastly, one might add egg yolk or egg yolk substitute in an amount of from about 27% to 35% based on the total weight of the egg or egg substitute, to the third element of the mixture, thereby completing the mixture comprising wheat flour or a wheat flour substitute, sugar or a sugar substitute, and egg or an egg substitute

The raw cake dough mixture is then poured into a pre-greased, rectangular, non toxic container suitable for baking in conventional baking devices, using conventional methods for greasing bake ware.

The rectangular, non toxic container suitable for baking in conventional baking devices containing the raw cake dough is then baked in a in a conventional baking device at a temperature of about 300 degrees Celsius for a period of 26 to 34 minutes so that the resulting product is a rectangular baked dough with an upper surface and a lower surface.

Once the baked dough has cooled to room temperature, the baked dough is removed from the rectangular, non toxic container and sliced perpendicular to the major sides of the rectangular baked dough creating four (4) equal rectangular portions, sub-portion A, sub-portion B, sub-portion C and sub-portion D, each sub-portion having an upper and a lower surface.

Sub-portion A, sub-portion B, sub-portion C, and sub-portion D are then sliced intermediately between the upper surface and lower surface of each sub-portion thereby creating eight (8) equal sub-sub-portions, sub-sub-portion E, sub-sub-portion F, sub-sub-portion G, sub-sub-portion H, sub-sub-portion I, sub-sub-portion J, sub-sub-portion K and sub-sub-portion L, each sub-sub-portion having an upper and a lower surface.

The upper surface of sub-sub-portion E, sub-sub-portion F, sub-sub-portion G, sub-sub-portion H, sub-sub-portion I, sub-sub-portion J, sub-sub-portion K and sub-sub-portion L are then dusted with a layer of finely powdered sugar or finely powdered sugar substitute.

The frozen confection is then prepared by softening the frozen confection using a blender or any other conventional mixing device until the frozen confection has achieved a fluid consistency, the blender or any other conventional mixing device is known by those of ordinary skill in the art.

The sandwiches are then constructed by pouring the softened frozen confection over the upper surfaces of sub-sub-portion E, sub-sub-portion F, sub-sub-portion G, and sub-sub-portion H so that the softened frozen confection lies over the upper surfaces of sub-sub-portion E, sub-sub-portion F, sub-sub-portion G, and sub-sub-portion H.

Then one might place sub-sub-portion I, sub-sub-portion J, sub-sub-portion K, and sub-sub-portion L on the softened frozen confection so that the lower surfaces of sub-sub-portion I, sub-sub-portion J, sub-sub-portion K and sub-sub-portion L contact the softened frozen confection.

And lastly, one might dust the upper surface of sub-sub-portion I, sub-sub-portion J, sub-sub-portion K and sub-sub-portion L with a layer of finely powdered sugar or finely powdered sugar substitute.

Once the sandwiches are constructed, the sandwiches are placed in a freezer or any other conventional freezing device until the sandwiches are frozen solid.

An advantage of the present invention is that it provides a frozen sandwich with a unique taste and texture.

Another advantage of the present invention is that it provides a food product that can be frozen for storage and thawed for consumption.

Yet another advantage of the present invention is that it provides a food product that is low in saturated fats, yet maintains an appealing flavor for consumers.

Although the present invention has been described in considerable detail with reference to certain preferred versions thereof, other versions are possible. Therefore, the spirit and the scope of the claims should not be limited to the description of the preferred versions contained herein.

What is claimed is:

1. A frozen sandwich comprising:
a first baked food product layer, having an upper surface and a lower surface;
a frozen confection layer having an upper surface and a lower surface, the frozen confection layer is positioned so that the upper surface of the frozen confection layer contacts the lower surface of the first baked food product layer; and
a second baked food product layer, having an upper surface and a lower surface, the second baked food product layer is positioned so that the upper surface of the second baked food product layer contacts lower surface of the frozen confection layer.

2. The frozen sandwich of claim 1, wherein the first baked food product layer is a cake.

3. The frozen convection sandwich of claim 2, wherein the second baked food product layer is a cake.

4. The frozen convection sandwich of claim 3, wherein the first baked food product layer contains wheat flour or a wheat flour substitute in an amount of from about 30% to about 38% based on the total weight of the first baked food product layer, sugar or a sugar substitute in an amount of from about 21% to 29% based on the total weight of the first baked food product layer, and egg or egg substitute in an amount of from about 35% to 43% based on the total weight of the first baked food product layer.

5. The frozen convection sandwich of claim 4, wherein the second baked food product layer contains wheat flour or a wheat flour substitute in an amount of from about 30% to about 38% based on the total weight of the second baked food product layer, sugar or a sugar substitute in an amount of from about 21% to 29% based on the total weight of the second baked food product layer, and egg or egg substitute in an amount of from about 35% to 43% based on the total weight of the second baked food product layer.

6. The frozen convection sandwich of claim 5, wherein the frozen confection layer is a frozen dairy product or frozen dairy product substitute.

7. The frozen convection sandwich of claim 6, wherein the frozen dairy product or frozen dairy product substitute is present in an amount of from about 71% to about 79% based on the total weight of the entire frozen convection sandwich comprising a first baked food product layer, a second baked food product layer, and a frozen convection layer.

8. A cake based ice cream sandwich comprising:
A first baked food product layer that is a cake, having an upper surface and a lower surface, wherein the a cake of the first baked food product layer contains wheat flour or a wheat flour substitute in an amount of from about 30% to about 38% based on the total weight of the first baked food product layer, sugar or a sugar substitute in an amount of from about 21% to 29% based on the total weight of the first baked food product layer, and egg or egg substitute in an amount of from about 35% to 43% based on the total weight of the first baked food product layer;
a frozen confection layer that is a frozen dairy product or frozen dairy product substitute having an upper surface and a lower surface, wherein the frozen dairy product or frozen dairy product substitute is present in an amount of from about 71% to about 79% based on the total weight of the entire ice cream sandwich comprising a first baked food product layer, a second baked food product layer, and a frozen convection layer, the frozen confection layer is positioned so that the upper surface of the frozen confection layer contacts the lower surface of the first baked food product layer; and
a second baked food product layer that is a cake, having an upper surface and a lower surface, wherein the a cake of the second baked food product layer contains wheat flour or a wheat flour substitute in an amount of from about 30% to about 38% based on the total weight of the second baked food product layer, sugar or a sugar substitute in an amount of from about 21% to 29% based on the total weight of the second baked food product layer and egg or egg substitute in an amount of from about 35% to 43% based on the total weight of the second baked food product layer.

9. A method for preparing a cake based frozen sandwich, said method comprising the steps of:
providing a cake dough mixture;
forming a cake dough mixture;
baking the cake dough mixture;
preparing the baked dough;
preparing a frozen confection;
building a sandwich by combining the baked dough with the frozen confection;
and
freezing the sandwich.

10. The method for preparing a cake based frozen sandwich of claim 9, wherein the forming a cake dough mixture step comprises the steps of:
providing a wheat flour or a wheat flour substitute in an amount of from about 30% to about 38% based on the total weight of the a cake dough mixture, sugar or a sugar substitute in an amount of from about 21% to 29% based on the total weight of the cake dough mixture, and egg or egg substitute in an amount of from about 35% to 43% based on the total weight of the cake dough mixture;
beating egg whites or egg whites substitute, in an amount of from about 54% to 62% based on the total weight of the egg or egg substitute, until the egg whites or egg white substitute is fluffy, thereby creating the first element of the cake dough mixture;
adding sugar or sugar substitute in an amount of from about 21% to 29% based on the total weight of the a cake dough mixture to the first element of the cake dough mixture, thereby creating the second element of the cake dough mixture;
adding wheat flour or wheat flour substitute in an amount of from about 30% to about 38% based on the total weight of the a cake dough mixture to the second element of the cake dough mixture, thereby creating the third element of the cake dough mixture; and
adding egg yolk or egg yolk substitute in an amount of from about 27% to 35% based on the total weight of the egg or egg substitute, to the third element of the cake dough mixture, thereby completing the cake dough mixture.

11. The method for preparing a cake based frozen sandwich of claim 10, wherein the baking the cake dough mixture step comprises the steps of:
greasing the interior surface area of a rectangular, non toxic container suitable for baking in conventional baking devices with an oil or oil substitute, both the rectangular, non toxic container and the oil or oil substitute are known by those of ordinary skill in the art;
pouring the cake dough mixture described in claim 10 into a rectangular, non toxic container suitable for baking in conventional baking devices;
placing the rectangular, non toxic container suitable for baking in conventional baking devices into a conventional baking device wherein the conventional baking device is preheated to 300 degrees Celsius; and
baking the cake dough mixture described in claim 10 in the conventional baking device at a temperature of 300 degrees Celsius for a period of 26 to 34 minutes so that the resulting product is a rectangular baked dough with an upper surface and a lower surface.

12. The method for preparing a cake based frozen sandwich of claim 11, wherein the preparing the baked dough step comprises the steps of:
allowing the baked dough as described in claim 11 to cool to room temperature;
removing the now room temperature baked dough from the rectangular non toxic container suitable for baking in conventional baking devices and cutting the rectangular baked dough perpendicular to the major sides of the rectangular baked dough into four (4) equal rectangular portions creating four (4) equal rectangular portions, sub-portion A, sub-portion B, sub-portion C and sub-portion D, each sub-portion having an upper and a lower surface;
slicing sub-portion A, sub-portion B, sub-portion C, and sub-portion D intermediately between the upper surface and lower surface of each sub-portion thereby creating thereby creating eight (8) equal sub-sub-portions, sub-sub-portion E, sub-sub-portion F, sub-sub-portion G, sub-sub-portion H, sub-sub-portion I, sub-sub-portion J, sub-sub-portion K and sub-sub-portion L, each sub-sub-portion having an upper and a lower surface; and
dusting the upper surface of sub-sub-portion E, sub-sub-portion F, sub-sub-portion G, sub-sub-portion H, sub-sub-portion I, sub-sub-portion J, sub-sub-portion K and sub-sub-portion L with a layer of finely powdered sugar or finely powdered sugar substitute.

13. The method for preparing a cake based frozen sandwich of claim 12, wherein the preparing a frozen confection step comprises the step of softening the frozen confection using a blender or any other conventional mixing device until the frozen confection has achieved a fluid consistency, the blender or any other conventional mixing device is known by those of ordinary skill in the art.

14. The method for preparing a cake based frozen sandwich of claim 13, wherein the building a sandwich by combining the baked dough with the frozen confection comprises the steps of:
pouring the softened frozen confection as described in claim 13 over the upper surfaces of sub-sub-portion E, sub-sub-portion F, sub-sub-portion G, and sub-sub-portion H so that the softened frozen confection lies over the upper surfaces of sub-sub-portion E, sub-sub-portion F, sub-sub-portion G, and sub-sub-portion H;
then placing sub-sub-portion I, sub-sub-portion J, sub-sub-portion K, and sub-sub-portion L on the softened frozen confection so that the lower surfaces of sub-sub-portion I, sub-sub-portion J, sub-sub-portion K and sub-sub-portion L contact the softened frozen confection; and
lastly, dusting the upper surface of sub-sub-portion I, sub-sub-portion J, sub-sub-portion K and sub-sub-portion L with a layer of finely powdered sugar or finely powdered sugar substitute.

15. The method for preparing a cake based frozen sandwich of claim 14, wherein the step of freezing the frozen sandwich comprises the step of placing the sandwiches as described in claim 14 into a conventional freezer or other freezing device capable of maintaining a constant temperature of −28 degrees Celsius until the sandwiches are frozen solid.

16. A method for preparing a cake based frozen ice cream sandwich, said method comprising the steps of:
providing a cake dough mixture;
forming the cake dough mixture, wherein the forming the cake dough mixture step comprises the steps of:
providing a wheat flour or a wheat flour substitute in an amount of from about 30% to about 38% based on the total weight of the a cake dough mixture, sugar or a sugar substitute in an amount of from about 21% to 29% based on the total weight of the cake dough mixture , and egg or egg substitute in an amount of from about 35% to 43% based on the total weight of the cake dough mixture;
beating egg whites or egg whites substitute, in an amount of from about 54% to 62% based on the total weight of the egg or egg substitute, until the egg whites or egg white substitute is fluffy, thereby creating the first element of the cake dough mixture;
adding sugar or sugar substitute in an amount of from about 21% to 29% based on the total weight of the a cake dough mixture to the first element of the cake dough mixture, thereby creating the second element of the cake dough mixture;
adding wheat flour or wheat flour substitute in an amount of from about 30% to about 38% based on the total weight of the a cake dough mixture to the second element of the cake dough mixture, thereby creating the third element of the cake dough mixture; and
adding egg yolk or egg yolk substitute in an amount of from about 27% to 35% based on the total weight of the egg or egg substitute, to the third element of the cake dough mixture, thereby completing the cake dough mixture;
baking the cake dough mixture, wherein the baking the cake dough mixture step comprises the steps of:
greasing the interior surface area of a rectangular, non toxic container suitable for baking in conventional baking devices with an oil or oil substitute, both the rectangular, non toxic container and the oil or oil substitute are known by those of ordinary skill in the art;
pouring the cake dough mixture into a rectangular, non toxic container suitable for baking in conventional baking devices;
placing the rectangular, non toxic container suitable for baking in a conventional baking devices into a conventional baking device wherein the conventional baking device is preheated to 300 degrees Celsius; and baking the cake dough mixture in the conventional baking device at a temperature of 300 degrees Celsius for a period of 26 to 34 minutes so that the resulting product is a rectangular baked dough with an upper surface and a lower surface.
preparing the baked dough, The method for preparing a cake based frozen sandwich of claim 11, wherein the preparing the baked dough step comprises the steps of:
allowing the baked dough as described in claim 11 to cool to room temperature;
removing the now room temperature baked dough from the rectangular non toxic container suitable for baking in conventional baking devices and cutting the rectangular baked dough perpendicular to the major sides of the rectangular baked dough into four (4) equal rectangular portions creating four (4) equal rectangular portions, sub-portion A, sub-portion B, sub-portion C and sub-portion D, each sub-portion having an upper and a lower surface;
slicing sub-portion A, sub-portion B, sub-portion C, and sub-portion D intermediately between the upper surface and lower surface of each sub-portion thereby creating thereby creating eight (8) equal sub-sub-portions, sub-sub-portion E, sub-sub-portion F, sub-sub-portion G, sub-sub-portion H, sub-sub-portion I, sub-sub-portion J, sub-sub-portion K and sub-sub-portion L, each sub-sub-portion having an upper and a lower surface; and
dusting the upper surface of sub-sub-portion E, sub-sub-portion F, sub-sub-portion G, sub-sub-portion H, sub-sub-portion I, sub-sub-portion J, sub-sub-portion K and sub-sub-portion L with a layer of finely powdered sugar or finely powdered sugar substitute.
preparing a frozen confection, The method for preparing a cake based frozen sandwich of claim 12, wherein the preparing a frozen confection step comprises the step of softening the frozen confection using a blender or any other conventional mixing device until the frozen confection has achieved a fluid consistency, the blender or any other conventional mixing device is known by those of ordinary skill in the art.
building a sandwich by combining the baked dough with the frozen confection, wherein the building a sandwich by combining the baked dough with the frozen confection comprises the steps of:
pouring the softened frozen confection as described in claim 13 over the upper surfaces of sub-sub-portion E, sub-sub-portion F, sub-sub-portion G, and sub-sub-portion H so that the softened frozen confection lies over the upper surfaces of sub-sub-portion E, sub-sub-portion F, sub-sub-portion G, and sub-sub-portion H;
then placing sub-sub-portion I, sub-sub-portion J, sub-sub-portion K, and sub-sub-portion L on the softened frozen confection so that the lower surfaces of sub-sub-portion I, sub-sub-portion J, sub-sub-portion K and sub-sub-portion L contact the softened frozen confection; and
lastly, dusting the upper surface of sub-sub-portion I, sub-sub-portion J, sub-sub-portion K and sub-sub-portion L with a layer of finely powdered sugar or finely powdered sugar substitute; and
freezing the sandwich, wherein the step of freezing the sandwich comprises the step of placing the sandwiches as described in claim 14 into a conventional freezer or any other freezing device capable of maintaining a constant temperature of −28 degrees Celsius until the sandwiches are frozen solid.
